(19) United States
(12) Patent Application Publication
(10) Pub. No.: US 2004/0256975 A1
(43) Pub. Date: Dec. 23, 2004

(54) Electrode and associated devices and methods

(75) Inventors: Bo Gao, Burlington, NC (US); Otto Z. Zhou, Chapel Hill, NC (US)

Correspondence Address: BURNS, DOANE, SWECKER & MATHIS, L.L.P., P.O. Box 1404, Alexandria, VA, 22313-1404, US

(73) Assignee: APPLIED NANOTECHNOLOGIES, INC.

(21) Appl. No.: 10/464,440

(22) Filed: Jun. 19, 2003

(51) Int. Cl. H01J 9/00; H01J 9/24; H01J 1/14; H01J 17/49

(52) U.S. Cl. 313/495; 445/24; 445/50; 313/582; 313/311

(57) ABSTRACT

This invention discloses electron field-emission cathodes with enhanced performance for vacuum and gaseous electronics and methods of fabricating these cathodes. The cathodes of the present invention comprise nanomaterials, such as carbon nanotubes, and metals or metal-containing compounds or alloys. In gas discharge devices, the present field-emission materials or cathodes work at room temperature and have much lower breakdown voltage or cathode fall (e.g.—the voltage drop between the plasma discharge region and the cathode) than conventional cathodes. The invention enables the developing of gas discharge devices with greatly enhanced energy efficiency and operating lifetime.

### FIELD OF THE INVENTION

The present invention is directed to an improved electrode construction. For example, the present invention is directed to a cathode construction incorporating nanostructure-containing materials having improved properties, including properties favouring improved activation and discharge characteristics. Associated devices incorporating such electrodes or cathodes, methods for producing the same, as well as methods for their use are comprehended.

### BACKGROUND OF THE INVENTION

Various constructions and techniques will be described below. However, nothing described herein should be construed as an admission of prior art. To the contrary, Applicants expressly reserve the right to demonstrate, where appropriate, that anything described herein does not qualify as prior art under the applicable statutory provisions.

Gas discharge devices have important applications in a wide variety of fields.

For example, they can be used as voltage stabilizers in electronics and radio engineering, as rectifiers in high power industrial systems, as surge arrester (e.g.—gas discharge tubes) in telecommunications, as domestic, medical and industrial lighting sources, as pixels in plasma displays, as nuclear particle counters, as noise generators, etc.

A typical gas discharge device includes an envelope filled with background gases and electrodes. Free electrons are emitted from a cathode and migrate to an anode. The electrons ionize the background gases and initiate a discharge in the process.

In conventional discharge devices, the electrons are liberated from a cathode by either thermionic or secondary emission mechanisms. Thermionic emission employs high temperatures, typically greater than 1000° C., to boil electrons from the cathode into the surrounding environment. For secondary emission, electrons are liberated when the cathode, typically made from materials with high secondary electron yield coefficients, is bombarded by ions, electrons, or photons. Gas discharge devices based on both of the mechanisms have to face many intrinsic shortcomings. For example, in a thermionic emission based device, the cathode materials would slowly evaporate into the surrounding environment because of the elevated temperature, causing a short lifetime of the cathode. The evaporated material could also deteriorate the performance of other components in the gas discharge devices, such as phosphor screen in luminous lighting. Finally, the heating would require extra power, which reduces the overall energy efficiency of the gas discharge device.

In a secondary electron emission based gas discharge device, such as a plasma display panel, the cathode fall is usually much higher than that of a thermionic-emission device in order to generate enough ions for a self-supporting discharge. Because electron emission from the cathode is primarily due to ion impact, a significant amount of energy beyond that required for liberating the electrons would be lost and transferred to the cathode during surface collision. This energy loss significantly reduces overall energy efficiency of the device. Furthermore, ion impact also results in sputtering of the cathode materials, which leads to shortened cathode lifetimes and poisoning of other components in the device, such as the phosphor screen in plasma display panels.

Electron field-emission cathodes can potentially solve many of these problems. In a field-emission-based gas discharge device, electrons are emitted from the cathode when a strong electric field is applied. Because the energy supplied to the cathode in this process is used only for liberating electrons, the energy efficiency of the device can be very high. Moreover, field-emission cathodes operate at room temperature. Thus, the lifetime of the cathode would be greatly enhanced because of the low evaporation rate at that temperature. However, conventional field-emission materials typically require the application of a very high electric field (about 10⁸-10¹⁰ V/cm) for electron emission and such high electric field is beyond the range of most gas discharge devices. Compared with conventional field emitters, carbon nanotube based field emitters need much lower electric field to operate and can achieve much higher emission current, which makes it possible to use them as cathodes in gas discharge devices, such as gas discharge tubes.

Among all the available techniques for synthesizing carbon nanotubes, laser-ablation and arc-discharge methods produce carbon nanotubes with a high level of structural perfection and therefore amongst the best electron field-emission properties. However, materials made therefrom are in the form of either porous membranes or powders that cannot be used directly on devices without further processing. Although the chemical vapor deposition (CVD) methods can grow carbon nanotubes directly on substrates, they require very high temperatures (600-1000° C.) and a reactive environment. Also, CVD grown carbon nanotubes generally do not have the same level of structural perfection and, as a result, lack the same emission properties as the tubes made by laser-ablation or arc-discharge methods. To fully utilize the excellent electron field-emission properties of carbon nanotubes, especially single wall carbon nanotubes made by laser-ablation and arc-discharge methods, some deposition techniques have been developed. Cathodes made by these techniques typically have a layer-by-layer geometry with a carbon nanotube layer on top of a substrate or a substrate with an adhesion enhancement layer (Fe layer, etc.).

U.S. Pat. No. ______ (Ser. No. 09/296,572 entitled “Device Comprising Carbon Nanotube Field Emitter Structure and Process for Forming Device”), the disclosure of which is incorporated herein by reference, in its entirety, discloses a carbon nanotube-based electron emitter structure.

U.S. Pat. No. ______ (Ser. No. 09/351,537 entitled “Device Comprising Thin Film Carbon Nanotube Electron Field Emitter Structure”), the disclosure of which is incorporated herein by reference, in its entirety, discloses a carbon nanotube field emitter structure having a high emitted current density.

U.S. Pat. No. 6,553,096 entitled “X-Ray Generating Mechanism Using Electron Field-Emission Cathode”, the disclosure of which is incorporated herein by reference, in its entirety, discloses an x-ray generating device incorporating a cathode formed at least in part with a nanostructure-containing material.

U.S. Patent Application Publication No. US-2002/0094064, entitled “Large-Area Individually Addressable Multi-Beam X-Ray System and Method of Forming Same”, the disclosure of which is incorporated herein by reference, in its entirety, discloses structures and techniques for generating x-rays which includes a plurality of stationary and individually electrically addressable field emissive electron sources.

U.S. Pat. No. ______ (Ser. No. 10/358,160 entitled “Method and Apparatus for Controlling Electron Beam Current”), the disclosure of which is incorporated herein by reference, in its entirety, discloses an x-ray generating device which allows independent control of the electron emission current by piezoelectric, thermal, or optical means.

U.S. Patent Application Publication No. US-2002/0140336, entitled “Coated Electrode with Enhanced Electron Emission and Ignition Characteristics”, the disclosure of which is incorporated herein by reference, in its entirety, discloses a coated electrode construction which incorporates nanostructure-containing materials.

U.S. Pat. No. ______ (Ser. No. ______, Attorney Docket No. 033627-005, entitled “Nanomaterial Based Electron Field-Emission Cathodes for Vacuum and Gaseous Electronics”), the disclosure of which is incorporated herein by reference, in its entirety, discloses electronics incorporating field-emission cathodes based at least in part on nanostructure-containing materials.

U.S. Pat. No. 6,385,292 entitled “Solid State CT System and Method”, the disclosure of which is incorporated herein by reference, in its entirety, disclose an x-ray source including a cathode formed from a plurality of addressable elements.

U.S. Patent Application Publication No. US-2002/0085674 entitled “Radiography Device With Flat Panel X-Ray Source”, the disclosure of which is incorporated herein by reference, in its entirety, discloses a radiography system having a solid state x-ray source that includes a substrate with a cathode disposed thereon within a vacuum chamber.

U.S. Pat. No. 6,385,292 entitled “X-Ray Generator”, the disclosure of which is incorporated herein by reference, in its entirety, discloses an x-ray generator which includes a cold field-emission cathode. The emissive current of the cathode can be controlled by various means.

### SUMMARY OF THE INVENTION

According to the present invention, cathodes have been formed with essentially only one layer that is composed of a mixture comprising a nanostructure-containing material as one of the components. According to the present invention, nanostructure-containing material is embedded in a matrix material, such that bonding between the nanostructure-containing material and the substrate is greatly enhanced. Also, vary the emission properties of the cathode can be varied by adjusting the composition of the mixture. According to one aspect of the present invention, the complexities and inefficiencies of multi-layer constructions can be avoided.

This invention also provides methods for fabricating nanomaterial based electron field-emission materials and cathodes, such as cathodes for vacuum electronics and gas discharge devices. Such cathodes have lower breakdown voltage or cathode fall than conventional cathodes. They can be used as key components to make novel vacuum electronics or gas discharge devices with improved performance, more specifically, extremely low turn-on field and extremely high current and current density. Gas discharge tubes with very low DC and impulse breakdown voltage, luminous lamps and plasma displays with enhanced energy efficiency, operation lifetime, and reduced manufacturing cost, are made possible through utilization of the concepts embodied by the present invention.

According to a first aspect, the present invention provides an electrode comprising a substrate electrode material, and at least one layer disposed on at least on a portion of a surface of the substrate electrode material, the at least one layer comprising a nanostrucutre-containing material and an adhesion-promoting material.

According to another aspect, the present invention provides a method of making an electrode, the method comprising the steps of: (i) forming a mixture comprising nanostrucutre-containing material and adhesion-promoting material; (ii) depositing the mixture onto at least a portion of a surface of a substrate electrode material thereby forming a substrate electrode material having at least one layer; and (iii) annealing the substrate electrode material having at least one layer.

According to a further aspect, the present invention provides a gas discharge tube comprising a pair of opposing electrodes, each electrode constructed as described above, a housing within which the opposing electrodes are contained, and an inert gas-containing environment contained within the housing.

According to yet another aspect, the present invention provides A plasma display cell comprising: upper and lower glass plates; at least one address electrode; at least one sustain electrode formed as described above; a chamber containing an excitable gas disposed between the at least one address electrode and the at least one sustain electrode; and a phosphor material lining at least a portion of the chamber.

According to another aspect, the present invention provides a gas discharge lamp comprising an anode and a cathode, the cathode in the form of an electrode constructed as described above, the anode and cathode, as well as a low-pressure gas environment contained within a sealed glass envelope, and a power supply connected to the anode and the cathode.

According to another aspect, the present invention provides a micro-discharge array comprising a base layer formed from a conductive material, an insulator layer provided on the base layer, and a conductive layer disposed on top of the insulator layer, a plurality of holes formed in the conductive layer and the insulator layer, and at least one layer comprising a nanostrucutre-containing material and an adhesion-promoting material disposed on the base layer and located within the plurality of holes.

### BRIEF DESCRIPTION OF THE DRAWINGS

FIG. 1 is a cross-sectional illustration of an electrode or cathode formed according to the principles of the present invention.

FIGS. 2a-2e are schematic illustrations of various forms of substrates from which electrodes or cathodes can be formed according to the principles of the present invention.

FIG. 3 is a schematic illustration of a process performed according to the principles of the present invention.

FIG. 4 is a schematic illustration of a gas discharge tube formed according to the principles of the present invention.

FIG. 5 is a schematic illustration of a plasma display cell constructed according to the principles of the present invention.

FIG. 6 is a schematic illustration of a gas discharge lamp formed according to the principles of the present invention.

FIGS. 7a-7b are schematic illustrations of a discharge array constructed according to the principles of the present invention.

### DETAILED DESCRIPTION OF THE INVENTION

Exemplary arrangements and techniques according to the present invention will now be described by reference to the drawing figures.

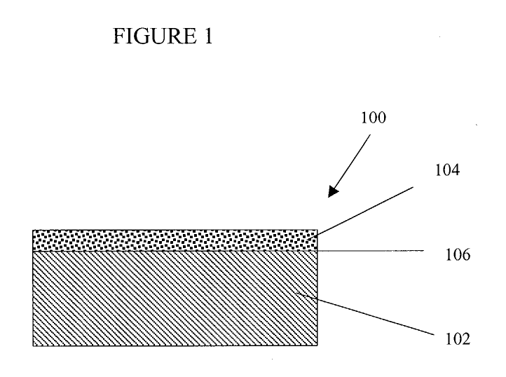

As illustrated in FIG. 1, a field-emission cathode 100 according to the present invention includes a conductive substrate 102 and a field-emission layer 104 covering at least a portion of the conducting substrate 102. According to a preferred embodiment, the field-emission layer 104 is applied directly to the substrate 102 thereby forming a substrate/field-emission layer interface 106.

In general, the substrate can be made of any suitable conductive material, such as metal, metal alloy, graphite, doped silicon. Alternatively, the substrate can be formed by a non-conductive material coated with a conductive layer, such as indium-tin oxide glasses, or glass or silicon wafer with deposited metal layer.

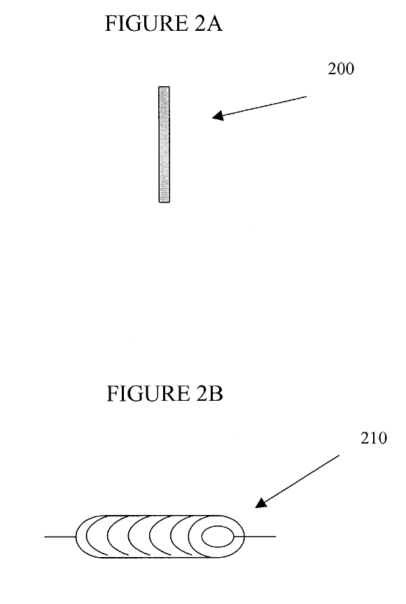

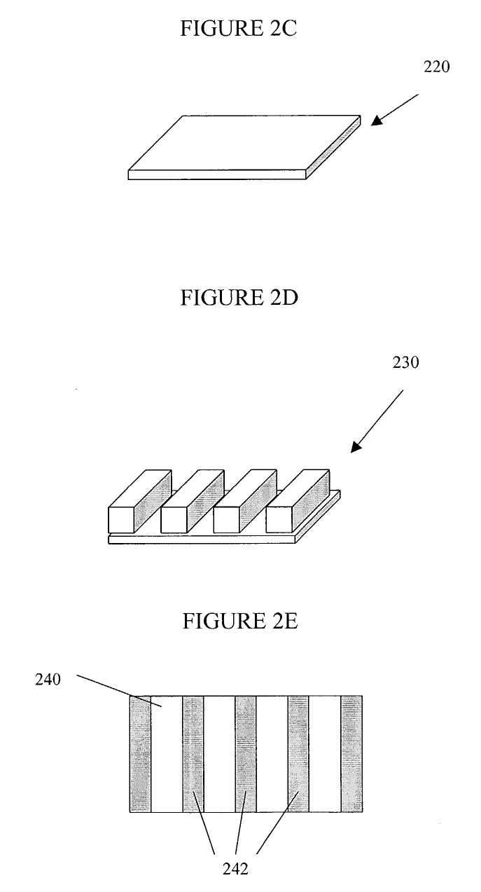

The geometry of the substrate can also vary with different applications, as illustrated in FIG. 2A-2E. As illustrated in FIG. 2A, the substrate can be in the form of a straight conductive wire 200. As illustrated in FIG. 2B, the substrate can be in the form of a coiled wire 210. As illustrated in FIG. 2C, the substrate can be in the form of a plate with a flat surface 220. As illustrated in FIG. 2D, the substrate may be in the form of a plate with a waffle-like surface configuration 230. As illustrated in FIG. 2E, the substrate can be in the form of a nonconductive plate, foil, wire, etc. 240, having one or more areas thereof covered with a conductive material or coating 242.

The field-emission layer comprises a mixture of one or more nanostructure—materials, and one or more metals, metal alloys and/or mixtures of thereof. The term “nanostructure material” is used by those familiar with the art to designate materials including nanoparticles such as C₆₀ fullerenes, fullerene-type concentric graphitic particles, metal, compound semiconductors such as CdSe, InP, nanowires/nanorods such as Si, Ge, SiOₓ, Ge, Oₓ, or nanotubes composed of either single or multiple elements such as carbon, BₓN_{y}, Cₓ, B_{y}, N_{z}, MoS₂, and WS₂. One of the common features of nanostructure materials is their basic building blocks. A single nanoparticle or a carbon nanotube has a dimension that is less than 500 nm in at least one direction. The term “nanostructure-containing” is intended to encompass materials which are composed entirely, or almost entirely of nanostructure materials, such as a material composed of nanostructure materials and a minor amount of impurities. The nanostructure-containing material may also include purposefully added materials and/or agents.

Preferably, the nanostructure material is in the form of carbon nanotubes. Carbon nanotubes can be purified or as formed single wall nanotubes (SWNTs), multi-wall nanotubes (MWNTs), or double wall carbon nanotubes (DWNTs), or mixtures thereof. Carbon nanotubes can be synthesized by laser-ablation, arc-discharge, chemical vapor deposition (CVD), plasma enhanced chemical vapor deposition (PECVD), or other suitable methods. Preferably, nanotubes used in this invention have a diameter of less than 100 nm. As-grown carbon nanotubes may contain a significant amount of impurities, such as amorphous carbon, metal catalyst (Ni, Co, Fe, Mo, Pd, Rh, and Au, etc.), and catalyst supporting materials, which include various kinds of oxides, such as Al₂O₃, SiO₂, MgO, and CaO, etc. Thus, optionally, according to the present invention, as-formed or as-grown nanostructure materials are purified prior to their incorporation into the cathode structure. Suitable purification techniques include, for example, an H₂O₂ refluxing procedure followed by filtration. See, for example, U.S. Pat. No. 6,553,096 for a more detailed explanation of this exemplary technique.

The adhesion-promoting material in the emission layer material mixture can be in the form of powders of pure metals such as Ti, Fe, etc., metal compounds such as titanium oxide, titanium carbide and titanium nitride, etc., alloys containing Ti, Au, Ag, Cu, Cr, Al, Mg, Co, Ni, and Fe, etc., or mixtures thereof. The particle sizes of the powder can be in the range from sub-micrometers to a few hundred micrometers. Preferably, they are sub-micrometer sized. The nanostructure material content in the mixture can be from about 0.01% to 90% by weight. Preferably, the content is about 0.1% to 10% by weight, and more preferably about 0.1% to 5% by weight. According to one embodiment of this invention, the metal particles are titanium-containing particles. The titanium content in the emission layer material mixture can vary from 1 to 99.9% by weight. Preferably, the titanium content should be from about 30% to 60% by weight, more preferably from about 50% to 60% by weight. In some cases, additional binder material can be added to the emission layer to promote good adhesion between the emission layer and the substrate. The binder can be various kinds of organic binders, such as epoxy resin and starch, etc., or glass frits, which contain a wide variety of oxides including PbO, B₂O₃, SiO₂, and Al₂O₃, etc. When present, the binder content in the mixture can be up to about 50%. According to a particularly preferred embodiment, the Ti content should be around 20% by weight.

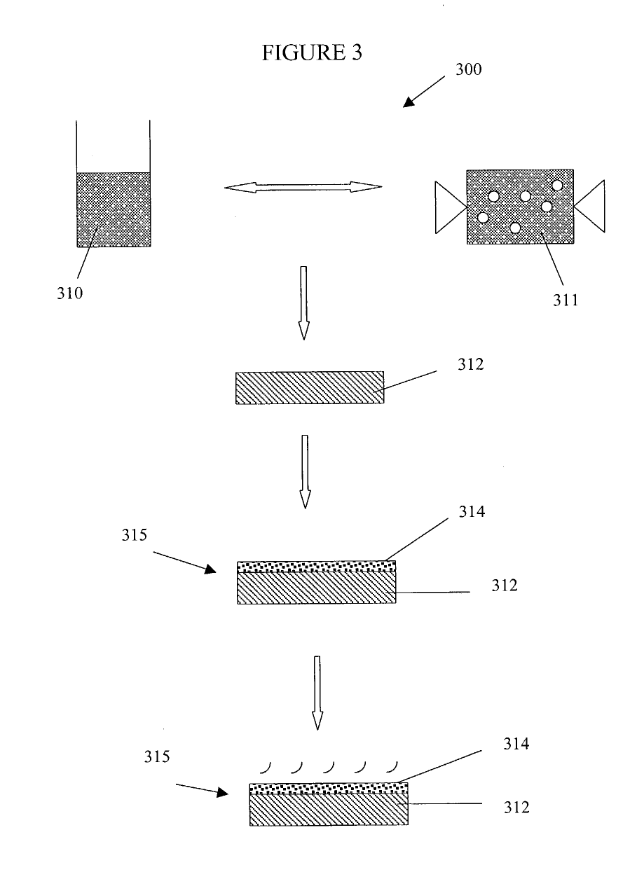

An illustrative technique 300 for constructing a field-emission cathode according to one embodiment of the present invention is shown in FIG. 3. According to the illustrated embodiment, nanostructure material (carbon nanotubes, etc.) are mixed with an adhesion-promoting material such as metal (Ti, etc.) particles or metal containing particles, (e.g.—metal compound particles or alloy particles), or mixtures thereof. When necessary or desirable, binder particles can also be added to the above mixture to promote the adhesion between the film and the substrate. The mixture 310 should be ultrasonically suspended in solvent for a sufficient period of time to achieve a uniform well-dispersed mixture of the different particles in the solvent. Alternatively the nanostructure material, adhesion-promoting material and optional binder material can be ball-milled with or without a solvent to achieve a uniform mixture 311. The mixture 310 or 311 is deposited on a substrate 312. Different deposition techniques can be employed to deposit mixtures 310 or 311, such as screen-printing, painting, dipping, spraying, doctor blade spreading or electrophoresis. Then, the coated cathode 315 is optionally vacuum annealed at a high temperature (up to 1200° C.), or fired in air at low temperature (lower than 500° C.) to get an adherent emission layer 314 on the substrate 312. As an optional additional step, excess emission materials that are not tightly bonded to the substrates 312 are removed after annealing. This can be accomplished by blowing dry air or dry nitrogen, or by a brief application of ultrasonic energy.

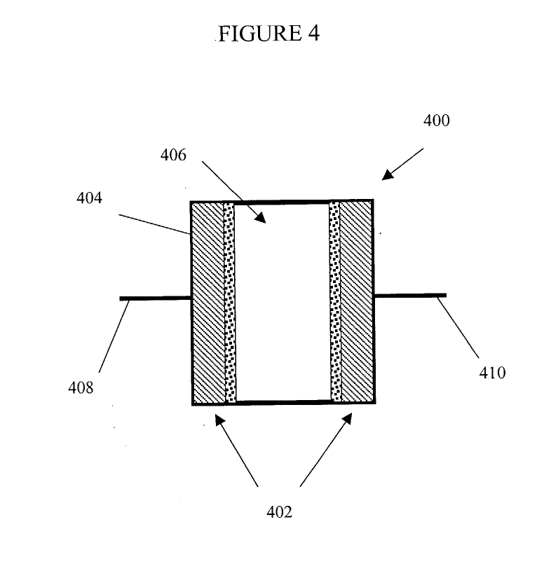

One of the promising applications of the nanomaterial based field-emission cathodes formed according to the present invention is their use as electrodes in gas discharge tubes (GDTs). GDTs are used in electric circuits, primarily telecommunications network interface device boxes and central office switching gears, to protect persons and equipment against transient over-voltages. As shown in FIG. 4, a typical GDT 400 is composed of two identical electrodes 402 constructed as described above sealed inside a ceramic cylinder 404 under an inert gas environment 406. In an electric circuit, a GDT is installed across two lines 408, 410, typically a power or signal line and a ground line. Under normal voltage, a GDT is insulating, typically with its impedance greater than 10,000 megohms. However, when a transient high voltage that exceeds the “breakdown” voltage of the GDT occurs on the power or signal line, the gas inside the tube would ionize and begin to conduct electricity. At the same time, the impedance of the GDT would drop from greater than 10,000 mega-ohms to only a few milliohms. Thus, the GDT essentially provides a near short circuit path to ground that prevents the high voltage surge from reaching the protected equipment in the circuit. After the transient voltage vanishes, the GDT returns to its insulating state and is ready to operate for another surge. GDTs are robust and inexpensive. They also have a relatively small shunt capacitance so that they do not limit the bandwidth of high frequency circuits as much as other nonlinear shunt components. Compared with solid-state protectors, GDTs can carry much higher currents. However, conventional GDTs are unreliable in terms of average turn-on voltage and run-to-run variability. Their impulse breakdown voltage is much higher than their DC breakdown voltage and is too high for many applications. Because of the relatively high electrical field required for plasma ignition in conventional GDTs, a small gap distance between the electrodes is often required. The small gap distance decreases the tolerance of the GDT because small variations in the gap distance during manufacturing results in large variability in breakdown voltage. The GDTs 400 made using electrodes 402 formed according to the present invention show improved performance compared with conventional GDTs, such as lower DC and impulse breakdown voltage, reduced breakdown voltage fluctuation, with less reliance on small electrode gaps.

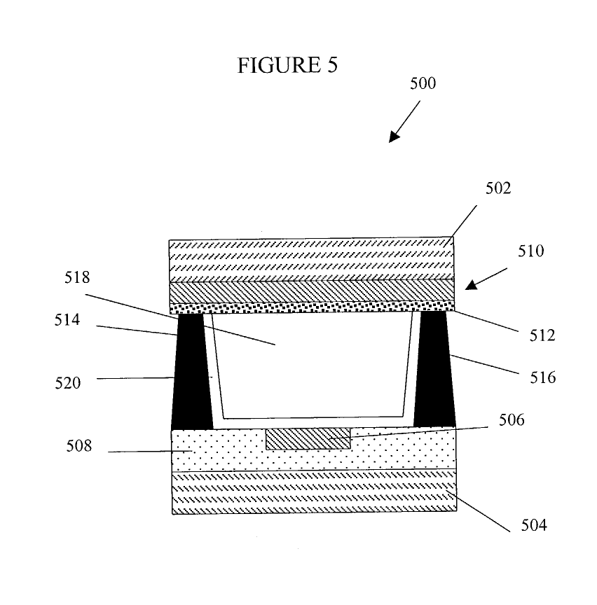

Another aspect of the present invention involves the incorporation of field-emission cathodes formed as described above into plasma discharge devices. FIG. 5 is a schematic illustration of one such device, namely an alternating-current plasma display cell 500. However, it should be noted that incorporation of field-emission cathodes formed consistent with the present invention may also be incorporated into other plasma discharge devices, such as a direct-current plasma display cell, as well as other similar devices.

As illustrated in FIG. 5, the cell 500 is sandwiched between an upper glass plate 502 and a lower glass plate 504. An address electrode 506 is located in the lower portion of the arrangement and is surrounded by dielectric material 508. A sustain electrode 510 is located in an opposing spaced relationship to the address electrode 508. Another layer(s) of dielectric material may be provided (not shown) between sustain electrodes. The address electrodes 508 and the sustain electrodes 510 typically are perpendicular to each other, thereby forming a grid-like structure with points of intersection laying over the interior of individual cells that make up an array. According to one aspect of the present invention, the sustain electrode(s) 510 is provided with a layer of nanostructure-containing material 512 formed as described above.

The electrodes 500, 510 are separated by dielectric barrier ribs 514, 516, thereby defining an interior chamber 518 of the cell 500. Typically, the chamber is filled with a reactive gas such as xenon or neon.

A layer of phosphor material 520 lines at least a portion of the interior chamber 518.

As current is applied, an electrical potential is created between the address electrode 506 and the sustain electrode 510. This potential is used to cause the sustain electrode 510, 512 to field-emit electrons. The emitted electrons stimulate the gas in chamber 518, thereby causing the gas to release ultraviolet photons. These photons interact with the phosphor layer 520, which causes the phosphor material to give off a visible light photon having a particular color. In typical plasma display cells, the electrodes are spaced apart by a distance on the order of 100 μm to 1 mm, and require a potential or voltage of 100-200V to generate emission. However, as explained previously, a field-emission electrode formed according to the present invention provides field emission at lower applied voltages, and is less dependent upon small electrode spacing. Thus, by providing these, and other, advantages, the cell 500 can provide enhanced performance and can be more easily manufactured than traditional plasma displays.

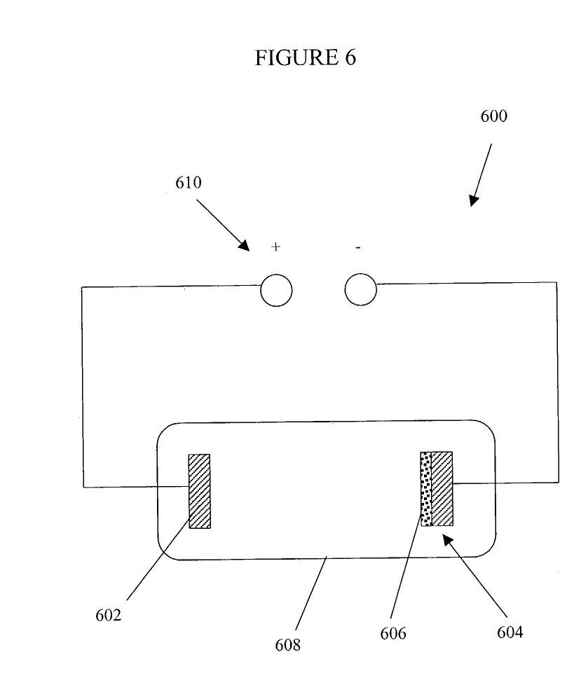

According to another aspect of the present invention, an improved gas discharge lamp can be constructed according to the principles of the present invention. Such a device is schematically illustrated in FIG. 6. The discharge lamp 600 comprises an anode 602 and opposing cathode 604 incorporating a nanostructure-containing material layer 606, as described herein. The anode 602 and cathode 604 are housed in a sealed glass envelope 608 containing a low-pressure gas environment. A power supply 610 is used to create an electrical potential between the anode 602 and the cathode 604, thereby resulting in the field emission of electrons. The emitted electrons excite the gasses contained in the envelope 608 thereby generating light. The electron emission causes ionizations. The ions accelerate toward the cathode and can act to liberate secondary electrons, thereby sustaining electron emission, and the emitted light resulting therefrom. The device 600 including the improved cathode 604 requires less applied voltage, thereby greatly enhancing performance, energy efficiency, operable lifetime, etc., when compared with conventional discharge lamps.

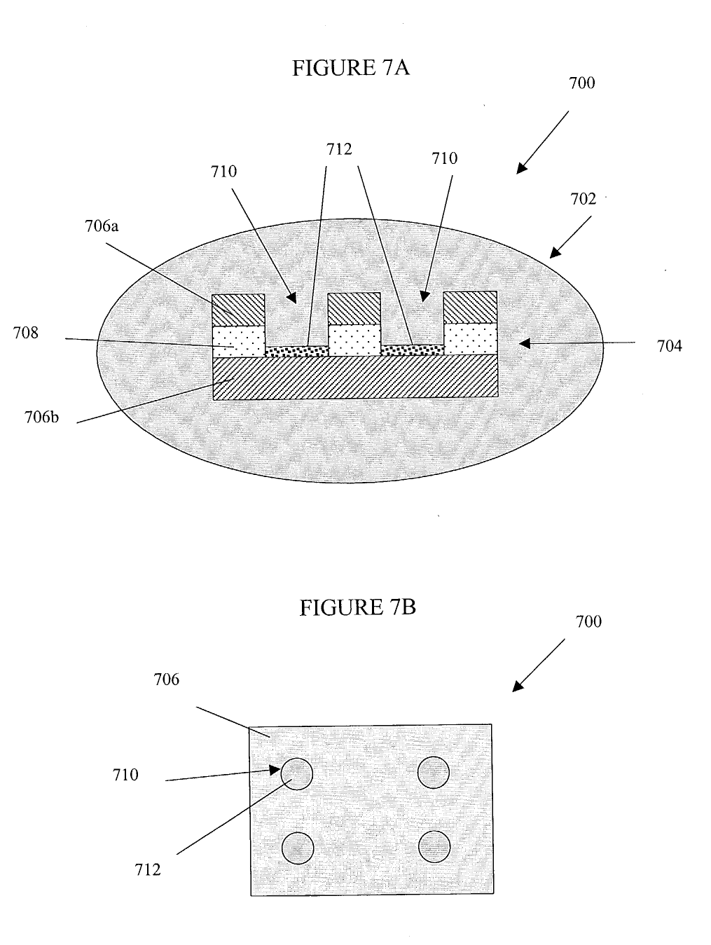

Another application of the principles of the present invention is illustrated in FIGS. 7A and 7B, namely the formation of a discharge array 700 or “micro-discharge array.” The array 700 is housed in a sealed gas environment 702. The array comprises a layered structure 704 comprising metal or conductive layers 706a, 706b, and an insulator layer 708. Holes 710 are formed in the structure 704, and nanostructure-containing materials layers 712 are formed within the holes, as previously described herein. The conductive layers 706a and 706b form separated electrodes. The distance of their separation is set by the thickness of the insulator layer 708. A power source (not shown) creates a potential difference between 706a and 706b, thereby causing the field emission of electrons.

Devices such as 700, which incorporate nanostructure-containing materials as described previously offer the pronounced advantages lower threshold field voltages, increased reliability, smaller size and improved manufacturing tolerances.

Devices such as 700 can find numerous uses, such as micro gas sensors, non-thermal plasma processing, plasma jets, etc.

### EXAMPLES

### Example 1

First, 1 part (by weight) purified SWNTs are carefully ground by a pestle and a mortar for up to 1 hours or ball-milled by a ball-milling machine for up to 20 minutes. The SWNTs can be made by a varied of methods such as laser ablation, arc-discharge or chemical vapor deposition method. One way to purify the SWNT is by H₂O₂ refluxing and filtration. See, for example, U.S. Pat. No. 6,553,096.

Then, 5 parts (by weight) Ti powders are added to the SWNTs and are ground in the mortar for up to 1 hour or ball-milled for up to another 20 minutes until a uniform mixture is achieved. The Ti particles were purchased from Aldrich that have purity over 98% and have average particle size around 10 μm. If necessary, some solvent, such as water, ethanol, methanol, acetone, etc., can be added to the mixture during grinding or ball-milling to help the SWNTs disperse.

The mixture is then spread over waffled surfaces of Cu substrates (see, e.g.—FIG. 2D) by a doctor blade. Finally, the cathodes are vacuum annealed (5×10⁻⁶ torr) at 850° C. for 30 minutes.

### Example 2

In this example, the field-emission layer is composed of a mixture of SWNTs, Ti powders and glass frits. The SWNTs are as-grown SWNTs synthesized by a chemical vapor deposition (CVD) method. The Ti particles are purchased from Aldrich and have purity over 98% and have average particle size around 10 μm. Glass frits (SCB-13 type) used in the mixture are from Kemco International Associates (KIA). The weight ratio between SWNTs, Ti particles and the glass frits is around 2/5/5.

Similar to example 1, at first 2 parts (by weight) of as-grown SWNTs are carefully ground by a mortal and pestle for up to 1 hours or ball-milled by a ball-milling machine for up to 20 minutes. Then, 5 parts (by weight) of Ti powders and 5 parts (by weight) of the glass frits are added to the as-grown SWNTs and are ground together for up to another hour or ball-milled together for up to another 20 minutes until a uniform mixture is achieved. If necessary, some solvent, such as water, ethanol, methanol, acetone, etc., can be added to the mixture during grinding or ball-milling to help the SWNTs disperse. The mixture is spread to waffled surfaces of Cu substrates by a doctor blade. Finally, the cathodes are vacuum annealed (5×10⁻⁶ torr) at 840° C. for 15 minutes.

| | | | Average DC | | Average | |
|---|---|---|---|---|---|---|
| | | | breakdown | impulse | Sig- | |
| Sample | | Pressure | voltage | Sigma | breakdown | ma |
| name | Gases | (mbar) | (V) | (V) | voltage (V) | (V) |
| Sample | Ne/Ar | 500 | 195 | 14 | 355 | 35 |
| 1 | (95/5) | | | | | |
| Sample | Ne/Ar | 800 | 80 | 5 | 223 | 28 |
| 2 | (95/5) | | | | | |

The experimental setup that was used to characterize the performance of the GDT as shown in Table 1 can be described as follows. The GDT and a sample holder are placed inside a vacuum chamber. The GDT has a bipolar configuration with two nanomaterial based electrodes formed as described above. The distance between the electrodes is set by the ceramic spacer. In our experiment, the distance is typically around 1-2 mm. The ceramic spacer also has an opening on its wall so that the space inside the GDT “sees” almost the same environment surrounding as the vacuum chamber. The GDT is attached to the sample holder by two stainless steel current collectors positioned opposite to each other. The current collectors make electric contact with the outside electronics through electric feed-throughs on the vacuum chamber. The chamber has two valves with one valve connected to a mechanic pump and the other valve connected to an inert gas line. To achieve desired inert gas environment, at first the system is evacuated when valve 1 is open and valve 2 is closed. Once the desired vacuum level (10⁻⁴ torr) is reached, one valve is closed and the system is flooded with inert gas to the predetermined pressure through the open second opened valve. Finally, both valves are fine-tuned (e.g.—with respect to the evacuating rate and the inert gas flow rate) to maintain the desired gas environment in the chamber. In our experiment, typically the DC breakdown voltage is measured using voltage rising rate of 1500V/s and impulse breakdown is measured when the ramping rate is 1000V/μs.

As shown in Table 1, electrodes of example 1 have an average DC breakdown voltage of 195V with a standard deviation of 15V. The electrodes from example 2 show an average DC breakdown voltage of 80V with a standard deviation of only 5V. Besides the excellent DC behaviors (e.g., low and stable DC breakdown voltages), the electrodes of the present invention also demonstrate much improved impulse behaviors compared with conventional GDTs. For example, current GDTs typically do not have impulse breakdown voltages below 500V. By comparison, the electrodes of the present invention show impulse breakdown voltages of only 355V in Example 1 and 223V in Example 2, which is around 200 to 300V lower than that of the conventional GDTs.

Experiments also indicate that the pressure and the composition of the inert gas mixture inside the GDT influence the performance and the discharge behaviors of the nanomaterial based electrodes. For example, the DC and impulse breakdown voltages are much lower and more stable in Ne or Ne/Ar mixture with high Ne content than in Ar or Ne/Ar mixture with low Ne content. Also, the DC and impulse breakdown voltages are lower and more stable in low gas pressure (lower than 100 mbar) than in relatively high pressure (from 100 mbar to 900 mbar).

The described embodiments of the present invention are intended to be illustrative rather than restrictive, and are not intended to represent every possible embodiment of the present invention. Various modifications can be made to the disclosed embodiments without departing from the spirit or scope of the invention as set forth in the following claims, both literally and in equivalents recognized in law.

While the present invention has been described by reference to the above-mentioned embodiments, certain modifications and variations will be evident to those of ordinary skill in the art. Therefore, the present invention is limited only by the scope and spirit of the appended claims.

We claim:

1. An electrode comprising a substrate electrode material, and at least one layer disposed on at least on a portion of a surface of the substrate electrode material, the at least one layer comprising a nanostrucutre-containing material and an adhesion-promoting material.

2. The electrode of claim 1, wherein the electrode is a field-emission cathode.

3. The electrode of claim 1, wherein the substrate electrode material is electrically conductive.

4. The electrode of claim 3, wherein the substrate electrode material formed from metal, metal alloy, graphite, doped silicon, or mixtures thereof.

5. The electrode of claim 1, wherein the substrate electrode material is formed from a non-conductive material having a conductive coating disposed thereon.

6. The electrode of claim 5, wherein the non-conductive material comprises glass or silicon.

7. The electrode of claim 5, wherein the conductive coating comprises metal films or indium-tin oxide films.

8. The electrode of claim 1, wherein the substrate electrode material is in the form of a straight wire, a coiled wire, a foil, a flat plate, or a plate with a waffle-like surface.

9. The electrode of claim 1, wherein the nanostructure-containing material comprises carbon nanotubes.

10. The electrode of claim 9, wherein the carbon nanotubes comprise single-walled carbon nanotubes.

11. The electrode of claim 1, wherein the adhesion-promoting material comprises an elemental metal, a metal compound, a metal alloy, or mixtures thereof.

12. The electrode of claim 11, wherein the adhesion promoting material comprises Ti, Fe, Au, Ag, Cu, Cr, Al, Mg, Co, Ni, titanium oxide, titanium carbide, titanium nitride, or mixtures thereof.

13. The electrode of claim 11, wherein the adhesion-promoting material in the form of particles having a size which is no greater than 1 micrometer.

14. The electrode of claim 1, wherein the at least one layer comprises 0.01-50 weight % nanostructure-containing material.

15. The electrode of claim 1, wherein the at least one layer comprises 30-99.9 weight % adhesion-promoting material.

16. The electrode of claim 1, wherein the at least one layer further comprises a binder material.

17. The electrode of claim 16, wherein the binder material comprises an organic binder material or glass frits.

18. The electrode of claim 16, wherein the at least one layer comprises 5-20 weight % binder material.

19. The electrode of claim 1, wherein the at least one layer is disposed directly upon the substrate electrode material, thereby forming a substrate electrode material—at least one layer interface.

20. A method of making an electrode, the method comprising the steps of:
(i) forming a mixture comprising nanostrucutre-containing material and adhesion-promoting material;
(ii) depositing the mixture onto at least a portion of a surface of a substrate electrode material thereby forming a substrate electrode material having at least one layer; and
(iii) annealing the substrate electrode material having at least one layer.

21. The method of claim 20, wherein step (i) comprises ultrasonically suspending particles of nanostructure-containing material and adhesion-promoting material in a solvent.

22. The method of claim 20, wherein step (i) comprises grinding or milling particles of nanostructure-containing material and adhesion-promoting material.

23. The method of claim 22, wherein the milling is performed with a solvent.

24. The method of claim 20, wherein step (ii) comprises screen printing, painting, dipping, spraying, doctor blade spreading, or electrophoresis.

25. The method of claim 20, wherein step (iii) comprises annealing in a vacuum at a temperature no greater than 1200° C.

26. The method of claim 20, wherein step (iii) comprises annealing under ambient pressure conditions at a temperature no greater than 500° C.

27. The method of claim 20, further comprising the step of:
(iv) removing excess, not well-adhered, material from the at least one layer.

28. The method of claim 27, wherein step (iv) comprises blowing dry air or dry nitrogen over the at least one layer.

29. The method of claim 27, wherein step (iv) comprises applying ultrasonic energy to the at least one layer.

30. A gas discharge tube comprising a pair of opposing electrodes, each electrode constructed according to claim 1, a housing within which the opposing electrodes are contained, and an inert gas-containing environment contained within the housing.

31. The gas discharge tube of claim 30, further comprising a power-in line connected to one of the electrodes and a ground line attached to the other electrode.

32. The gas discharge tube of claim 30, exhibiting an average DC breakdown voltage of less than 200V and an average impulse breakdown voltage of less than 500V.

33. The gas discharge tube of claim 32, wherein the average impulse breakdown voltage is less than 360V.

34. A plasma display cell comprising:
upper and lower glass plates;
at least one address electrode;
at least one sustain electrode formed according to claim 1;
a chamber containing an excitable gas disposed between the at least one address electrode and the at least one sustain electrode; and
a phosphor material lining at least a portion of the chamber.

35. A gas discharge lamp comprising an anode and a cathode, the cathode in the form of an electrode constructed according to claim 1, the anode and cathode, as well as a low-pressure gas environment contained within a sealed glass envelope, and a power supply connected to the anode and the cathode.

36. A micro-discharge array comprising a base layer formed from a conductive material, an insulator layer provided on the base layer, and a conductive layer disposed on top of the insulator layer, a plurality of holes formed in the conductive layer and the insulator layer, and at least one layer comprising a nanostrucutre-containing material and an adhesion-promoting material disposed on the base layer and located within the plurality of holes.

37. The micro-discharge array of claim 36, wherein the base layer, insulator layer, conductive layer, and at least one layer comprising a nanostrucutre-containing material and an adhesion-promoting material is contained within a sealed gas environment.
